(19) United States
(12) Patent Application Publication
(10) Pub. No.: US 2023/0064368 A1
(43) Pub. Date: Mar. 2, 2023

(54) PNEUMATIC AVIATION TIRE

(71) Applicant: The Goodyear Tire & Rubber Company, Akron, OH (US)

(72) Inventor: Romain Jack Rodolphe Mersch, Boust (FR)

(21) Appl. No.: 17/411,629

(22) Filed: Aug. 25, 2021

(51) Int. Cl. B60C 9/00; B60C 9/20

(52) U.S. Cl. CPC B60C 9/005; B60C 9/0042; B60C 9/20; B60C 9/2003; B60C 2200/02; B60C 2009/2035; B60C 2009/2077; B60C 2009/2096; B60C 2009/0092

(57) ABSTRACT

A tire includes a carcass, a tread disposed radially outward of the carcass, a sidewall including a shoulder extends toward the tread, and a reinforcing structure positioned radially between the carcass and the tread. The reinforcing structure includes a plurality of belts extending axially toward the shoulder and an overlapping spiral wound strip positioned at a radially outermost portion of the reinforcing structure. The overlapping spiral wound strip includes a uniform width having groups of four first cords with a single second cord therebetween. The first cords include a hybrid construction and the second cords include a single material construction.

### FIELD OF THE INVENTION

The present invention relates to pneumatic and non-pneumatic tires and, more specifically, to tires for aircraft service having shoulder reinforcement.

### BACKGROUND OF THE INVENTION

Tires for service on aircraft landing gears are exposed to severe operating conditions of load and acceleration/speed. In particular, aviation tires coupled with the landing gears of large commercial airliners are susceptible to severe deformation upon landing, takeoffs, and controlled movement of the aircraft under its own power while on the ground (e.g., taxiing, parking, etc.). Loss of a landing gear tire on takeoff (e.g., a blowout, mechanical failure, etc.) may result in an aborted take-off or an emergency landing. Loss of a landing gear tire upon landing may result in an inability to halt the airliner's momentum, leading to runway overshoot. Airliners often elevate tire temperature by taxiing long distances and/or by taxiing at high speed, which may increase the susceptibility to blowouts during takeoff or after landing.

Typically, the belt package incorporated into conventional aviation tires includes a number of cut belt layers and a number of spiral wound layers formed from cord reinforced strip(s) wound about the circumference of belt layers of the tire with a zero degree spiral overlay. The spiral wound layers terminate proximate the tire shoulder of the tire with little or no overlap, as the winding direction is reversed to apply the successive spiral wound layers.

One conventional approach for improving tire durability is a uniform increase in the number of belt layers from crown to shoulder. However, this approach may result in significant tire weight increases. Tire weight increase from the added layers is contrary to another tire design parameter for minimizing the net weight of the airliner. Increasing the number of belt layers uniformly between the crown and the shoulder also significantly increases the tire's production cost (e.g., more material, more complexity, more waste, etc.). For these and other reasons, it would be desirable to provide a lightweight tire for airliner landing gears characterized by improved durability and greater load capability.

### SUMMARY OF THE INVENTION

A tire in accordance with the present invention includes a carcass, a tread disposed radially outward of the carcass, a sidewall including a shoulder extends toward the tread, and a reinforcing structure positioned radially between the carcass and the tread. The reinforcing structure includes a plurality of belts extending axially toward the shoulder and an overlapping spiral wound strip positioned at a radially outermost portion of the reinforcing structure. The overlapping spiral wound strip includes a uniform width having groups of four first cords with a single second cord therebetween. The first cords include a hybrid construction and the second cords include a single material construction.

According to another aspect of the tire, the first cords have a hybrid construction of nylon and aramid.

According to still another aspect of the tire, the second cords have a full nylon construction.

According to yet another aspect of the tire, the first cords have a hybrid construction and the second cords have a 1400 dtex/2 single material construction.

According to still another aspect of the tire, the first cords have a full nylon construction and the second cords have a 1840 dtex/3 full rayon construction.

According to yet another aspect of the tire, the first cords have a full aramid construction.

According to still another aspect of the tire, the second cords have a 2+4 full nylon construction.

A method of constructing a tire, in accordance with the present invention, includes the steps of: axially extending a carcass from a first bead portion to a second bead portion; axially extending a tread radially outward of the carcass; extending a sidewall radially outward to a shoulder adjacent the tread; positioning a reinforcing structure radially between the carcass and the tread; spirally winding an overlapping strip at a radially outermost portion of the reinforcing structure. The overlapping strip includes a uniform width having groups of four first cords with a single second cord therebetween. The first cords include a hybrid construction and the second cords includes a single material construction.

According to another aspect of the method, the first cords have a hybrid construction of nylon and aramid.

According to still another aspect of the method, the second cords have a full nylon construction.

According to yet another aspect of the method, the first cords have a hybrid construction and the second cords have a 1400 dtex/2 single material construction.

According to still another aspect of the method, the first cords have a full nylon construction and the second cords have a 1840 dtex/3 full rayon construction.

According to yet another aspect of the method, the first cords have a full aramid construction.

According to still another aspect of the method, the second cords have a 2+4 full nylon construction.

### Definitions

“Axial” and “axially” means the lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Carcass” means the tire structure apart from the belt structure, tread, undertread, and sidewall rubber over the plies, but including the beads.

“Cord” means one of the reinforcement strands of which the plies in the tire are comprised.

“Crown” refers to substantially the outer circumference of a tire where the tread is disposed.

“Circumferential” means circular lines or directions extending along the surface of the sidewall perpendicular to the axial direction.

“Cut belt or cut breaker reinforcing structure” means at least two cut layers of plies of parallel cords, woven or unwoven, underlying the tread, unanchored to the bead, and having both left and right cord angles in the range from 10 degrees to 33 degrees with respect to the equatorial plane of the tire.

“Equatorial plane (EP)” means the plane perpendicular to the tire's axis of rotation and passing through the center of its tread.

“Inner” means toward the inside of the tire.

“Lateral” means a direction parallel to the axial direction, as in across the width of the tread or crown region.

“Outer” means toward the tire's exterior.

“Pneumatic tire” means a laminated mechanical device of generally toroidal shape, usually an open-torus having beads and a tread and made of rubber, chemicals, fabric and steel or other materials.

“Radial” and “radially” mean directions radially toward or away from the axis of rotation of the tire.

“Shoulder” means the upper portion of the sidewall just below the tread edge.

“Sidewall” means that portion of a tire between the tread and the bead area.

“Tread” means a molded rubber component which, when bonded to a tire casing, includes that portion of the tire that comes into contact with the road when the tire is normally inflated and under normal load.

### BRIEF DESCRIPTION OF THE DRAWINGS

The invention will be described by way of example and with reference to the accompanying drawings in which:

FIG. 1 is a schematic view of an example belt package for use with the present invention;

FIG. 2 is a schematic cross-sectional view of the example tire of FIG. 1;

FIG. 3 is a schematic enlarged view of a portion of FIG. 2;

FIG. 4 is a schematic view of another example belt package for use with the present invention; and

FIG. 5 is a schematic cross-sectional view of an overlay strip in accordance with the present invention.

### DETAILED DESCRIPTION OF EXAMPLES OF THE PRESENT INVENTION

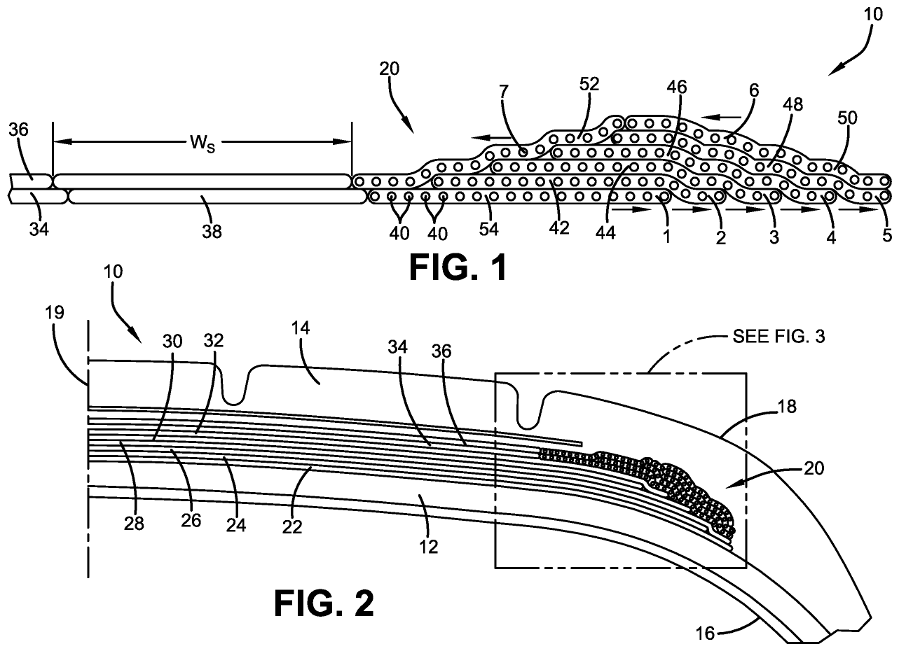

With reference to FIGS. 1-3, an example pneumatic aviation tire 10 suitable for airliner service as a nose gear tire may include a carcass 12, a ground-engaging tread 14, a sidewall 16, and a shoulder 18 defined by the junction of the sidewall 16 and the tread 14. When mounted on the airliner, the tread 14 may furnish traction and the tire 10 may contain a fluid (e.g., air, nitrogen, etc.) that sustains part of the airliner load. The example tire 10 may have mirror symmetry reflecting about an equatorial plane 19 bisecting tire 10. Arranged between the carcass 12 and the tread 14 may be a belt package, generally indicated by reference numeral 20, characterized by a plurality of, for example six, individual cut belt plies or layers 22, 24, 26, 28, 30, 32 and a plurality of, for example two, spiral wound belt layers 34, 36 positioned radially-outward from the cut belt layers 22, 24, 26, 28, 30, 32. The number of cut belt layers and spiral wound layers in the belt package 20 may vary according to the tire construction.

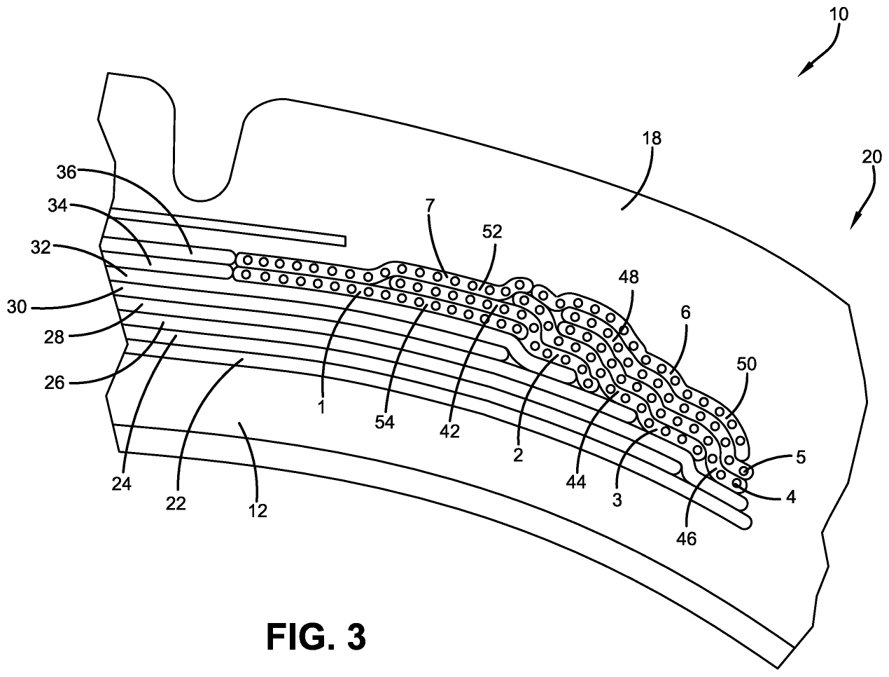

As best shown in FIGS. 1 and 3, both of the spiral wound belt layers 34, 36 may be formed by a continuous rubberized flat strip 38 that is wound circumferentially (e.g., with a −5 degree to +5 degree spiral overlay) about the tire 10. The overlay 34, 36 may extends one tire shoulder 18 to the other tire shoulder (not shown). The flat strip 38 may be reinforced with multiple embedded high modulus, essentially inextensible, cords 40 of, for example, nylon, rayon, polyester, aramid, glass, and/or metal disposed spatially with a substantially parallel arrangement of one to another and covered by a elastomer matrix, such as a cured rubber casing. The width Ws of flat strip 38 may range from about 6 mm to about 20 mm, or about 10 mm. The thickness of flat strip 38 may approximate several millimeters. The density of cords 40 of the flat strip 38 may be between 18 and 22 per inch. During construction of tire 10, the flat strip 38 may be wound circumferentially about a crowned building drum with the flat strip 38 being shifted by a transverse, or axial, distance approximately equal to, or slightly greater than, the width Ws with each individual turn.

The axial dimension of the cut belt layers 22, 24, 26, 28, 30, 32 may be selected such that corresponding lateral side edges are tiered or staggered with an overlapping relationship near the tire shoulder 18. For example, the cut belt layer 22 may extend laterally/axially for a greater lateral distance from the equatorial plane 19 than the cut belt layer 24 so that the terminal side edge of the cut belt layer 24 may overlap between layers 22 and 26.

A plurality of overlapping spiral wound shoulder layers 42, 44, 46, 48, 50, 52, 54 may be provided in the tire shoulder 18. Each of the spiral wound shoulder layers 42, 44, 46 may be defined by a single circumferential flat strip, similar to the flat strip 38, in which adjacent turns are shifted laterally by less than one strip width (Ws) so that the shoulder layers 42, 44, 46 have a partially overlapping, or staggered relationship (FIG. 3). In other words, the winding pitch for spiral wound shoulder layers 42, 44, 46 may be less than one strip width (Ws) per revolution. The remaining spiral wound shoulder layers 48, 50, 52, 54 may be applied with a winding pitch equal to one strip width (Ws) per revolution such that there is no overlapping build up in the tire crown region beyond the overlap afforded by spiral wound belt layers 34, 36. The lateral shift of less than one strip width (Ws) is shown in FIGS. 1-3 as adjacent turns of the flat strip 38 contribute to the partially overlapping relationship. In a central region of the tire shoulder 18, an overlapping relationship may thereby be established to provide an ultimate thickness equivalent to six strip thicknesses.

With continued reference to FIGS. 1-3, to apply the spiral wound shoulder layers 42, 44, 46, 48, 50, 52, 54, the first spiral wound belt layer 34 may be applied to the tire 10. After the shoulder layer 54 is applied, the winding pitch may be changed from greater than or equal to one strip width (Ws) per revolution (e.g., a −5 degree to +5 degree pitch) to a winding pitch that is less than one strip width (Ws) per revolution. In the example belt package 20 of FIGS. 1-3, the spiral wound shoulder layers 42, 44, 46 may be shifted laterally by approximately 0.2 of the strip width (Ws) per revolution. The spiral wound shoulder layers 42, 44, 46 may be applied serially or sequentially from left to right, as best visible in FIG. 1. The spiral wound shoulder layers 48, 50 may be applied with a winding pitch of approximately zero degrees so that the shoulder layers 48, 50 may roughly overlap the shoulder layer 48. Then, the winding pitch may be reverted to greater than or equal to one strip width (Ws) per revolution. The spiral wound shoulder layer 52 may be applied with a unitary winding pitch of one strip width (Ws), in an opposite or reverse winding direction from the shoulder layers 42, 44, 46. After the shoulder layer 52 is applied, the circumferential turns of the flat strip 38 may transition into forming the spiral wound belt layer 36. At the tire shoulder opposite the tire shoulder 18, another set of spiral wound shoulder layers (not shown but similar to spiral wound shoulder layers 42, 44, 46, 48, 50, 52) may be applied to tire 10.

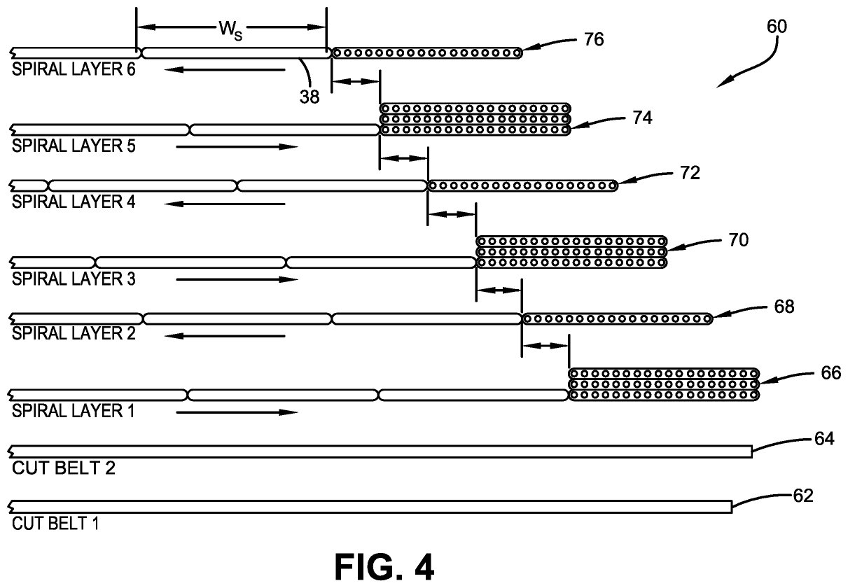

With reference to FIG. 4, another example belt package for use with the present invention, a belt package 60 for an example tire (not shown, but similar to the tire 10 of FIGS. 1-3) may include a plurality of cut belts 62, 64 and a plurality of spiral wound belt layers 66, 68, 70, 72, 74, 76 wound with a zero degree spiral. The laterally outermost turn of the spiral wound belt layer 66 may be aligned radially with the free side edge of the underlying cut belt 64. The laterally outermost turn of the spiral wound belt layer 68 may be shifted laterally by less than one strip width (Ws), although the winding pitch remains constant at greater than or equal to about one strip width (Ws). Each successive spiral wound belt layer 70, 72, 74, 76 may likewise be shifted laterally by less than one strip width (Ws) while the winding pitch remains constant at greater than or equal to about one strip width (Ws). In other words, when the winding direction is reversed at the turn around positions at each tire shoulder 18 (FIG. 1), an initial strip turn of each spiral wound belt layer 66, 68, 70, 72, 74, 76 may be shifted laterally by less than one strip width (Ws) so that radially adjacent pairs of the spiral wound belt layers 66, 68, 70, 72, 74, 76 may be only partially overlapping. Alternating spiral wound belt layers, for example spiral wound belt layers 66, 68, 72, may include multiple overlapping initial turns of the flat strip 38 wound with a zero pitch. Two cut belts and six spiral wound belt layers may be provided in the belt package 60 and the lateral shift distance for successive spiral wound belt layers may be about 0.33 of the strip width (Ws).

The overlapping turns of flat strip 38 at the lateral edge of the spiral wound belt layers may create a tiered arrangement such that the lateral shift in the starting location for successive spiral wound belt layers 66, 68, 70, 72, 74, 76 and the lateral edges among successive spiral wound belt layers 66, 68, 70, 72, 74, 76 are not coincident. The spiral wound belt layer 66 may contribute three overlapping spiral wound shoulder layers. The spiral wound belt layer 68 may contribute one partially overlapping spiral wound shoulder layer. The spiral wound belt layer 70 may contribute three partially overlapping spiral wound shoulder layers.

In accordance with the present invention, an overlay construction, such as above described 34, 36, 38, may include multiple cord materials. Current manufacturing methods may allow an overlay construction in accordance with the present invention to include multiple reinforcement cords co-extruded in a single step. An overlay strip, such as the flat strip 38, may comprise two or more single end dipped cords of different materials. The overlay strip may have a width between 10 mm and 15 mm, or 10 mm. For example, the overlay strip width may include seven hybrid cords of aramid/nylon and two nylon cords, in place of eight cords of hybrid material for a conventional overlay strip, such as the spiral layers 34, 36 and the flat strip 38.

Conventional overlay strips have been made entirely of a single reinforcement material, such as full nylon, hybrid nylon and aramid, or full aramid. The application of single dipped fabrics (made of a single cord type), one at a time, for calendering/slitting operations may allow varying cord types within a single overlay strip. Such a combination of different cord materials within a single strip may thereby enhance functional properties while decreasing cost and/or weight of the overlay package. The insertion of one of more full nylon cords into an overlay strip usually made entirely of hybrid cords may further increase shrink force at higher speeds when the tire starts to heat-up, leading to a more stable tire circumference at high speeds, with potential benefits in high speed performance.

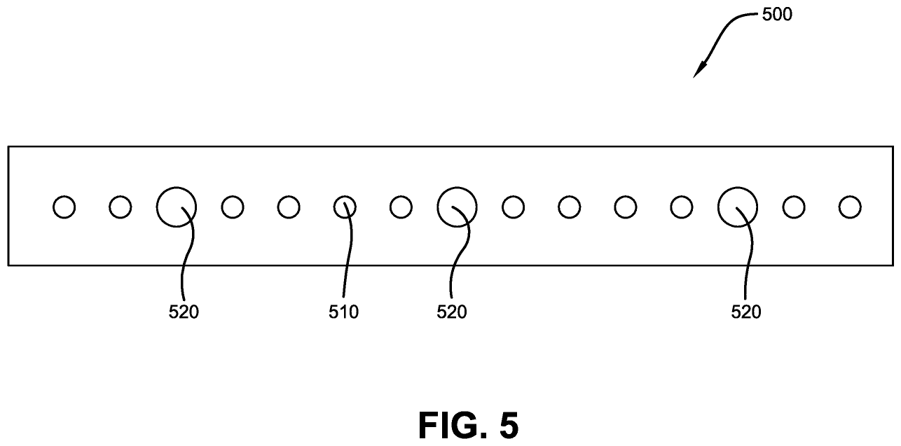

As shown in FIG. 5, the width of an example overlay strip 500 in accordance with the present invention may include groups of four first cords 510 with a single second cord 520 therebetween. The first cords 510 may include a hybrid construction, a full nylon construction, or a full aramid constriction. The second cords 520 may include a hybrid construction, a full nylon construction, or a full aramid constriction.

In a first example, the first cords 510 may be a hybrid of nylon and aramid and the second cords 520 may be full nylon. In a second example, the first cords 510 may be of hybrid construction and the second cords 520 may be 1400 dtex/2 of a single material construction. In a third example, the first cords 510 may be full nylon and the second cords 520 may be 1840 dtex/3 of full rayon construction. In a fourth example, the first cords 510 may be of full aramid construction and the second cords 520 may be 2+4 full nylon construction.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed:

1. A tire comprising:
a carcass;
a tread disposed radially outward of the carcass;
a sidewall including a shoulder extends toward the tread; and
a reinforcing structure positioned radially between the carcass and the tread, the reinforcing structure including a plurality of belts extending axially toward the shoulder and an overlapping spiral wound strip positioned at a radially outermost portion of the reinforcing structure, the overlapping spiral wound strip including a uniform width having groups of four first cords with a single second cord therebetween, the first cords including a hybrid construction and the second cords including a single material construction.

2. The tire as set forth in claim 1 wherein the first cords have a hybrid construction of nylon and aramid.

3. The tire as set forth in claim 2 wherein the second cords have a full nylon construction.

4. The tire as set forth in claim 1 wherein the first cords have a hybrid construction and the second cords have a 1400 dtex/2 single material construction.

5. The tire as set forth in claim 1 wherein the first cords have a full nylon construction and the second cords have a 1840 dtex/3 full rayon construction.

6. The tire as set forth in claim 1 wherein the first cords have a full aramid construction.

7. The tire as set forth in claim 6 wherein the second cords have a 2+4 full nylon construction.

8. A method of constructing a tire comprising the steps of:
axially extending a carcass from a first bead portion to a second bead portion;
axially extending a tread radially outward of the carcass;
extending a sidewall radially outward to a shoulder adjacent the tread;
positioning a reinforcing structure radially between the carcass and the tread; and
spirally winding an overlapping strip at a radially outermost portion of the reinforcing structure, the overlapping strip including a uniform width having groups of four first cords with a single second cord therebetween, the first cords including a hybrid construction and the second cords including a single material construction.

9. The method as set forth in claim 1 wherein the first cords have a hybrid construction of nylon and aramid.

10. The method as set forth in claim 9 wherein the second cords have a full nylon construction.

11. The method as set forth in claim 8 wherein the first cords have a hybrid construction and the second cords have a 1400 dtex/2 single material construction.

12. The method as set forth in claim 8 wherein the first cords have a full nylon construction and the second cords have a 1840 dtex/3 full rayon construction.

13. The method as set forth in claim 8 wherein the first cords have a full aramid construction.

14. The method as set forth in claim 13 wherein the second cords have a 2+4 full nylon construction.
